(19) United States
(12) Patent Application Publication
(10) Pub. No.: US 2026/0336354 A1
(43) Pub. Date: Oct. 29, 2026

(54) SENSING DEVICE AND STEERING WHEEL

(71) Applicant: TOYODA GOSEI CO., LTD., Kiyosu-shi (JP)

(72) Inventors: Itsuhiko HIROTA, Aichi (JP); Rie ONO, Aichi (JP)

(21) Appl. No.: 19/659,299

(22) Filed: Apr. 27, 2026

(30) Foreign Application Priority Data
Apr. 28, 2025 (JP) 2025-074419

(51) Int. Cl. B60H 1/00; H05B 1/02

(52) U.S. Cl. CPC B60H 1/00292; H05B 1/0252

(57) ABSTRACT

A sensing device includes: a load unit including a conductive portion and a base material portion; a covering portion; a sensor circuit configured to detect an object in contact with the covering portion; and a heater circuit configured to cause the conductive portion to generate heat. The sensor circuit includes a sensor wiring connection portion electrically connected to the conductive portion. The heater circuit includes a positive wiring connection portion and a negative wiring connection portion supported by the base material portion in the load unit, and is configured to heat the conductive portion between the positive and negative wiring connection portions. In a cross-section showing a laminated structure of the conductive portion and the covering portion, the sensor wiring connection portion, and the positive and negative wiring connection portions are positioned apart from one another while being in contact with a layer representing the conductive portion.

### CROSS-REFERENCE TO RELATED APPLICATIONS

This application is based upon and claims the benefit of priority from prior Japanese patent application No. 2025-074419, filed on Apr. 28, 2025, the entire contents of which are incorporated herein by reference.

### TECHNICAL FIELD

The present disclosure relates to a sensing device and a steering wheel.

### BACKGROUND ART

A steering wheel including a touch sensor that detects gripping of a driver and a heater that warms a rim, as described in JP2025-27750A, is known. In a cross-section of the rim of JP2025-27750A, a layer of the touch sensor and a layer of the heater are laminated via an insulator interposed therebetween. The layer of the touch sensor includes a layer constituting an electrode that detects the gripping. The layer of the heater includes a layer constituting a heat generation element. A metal material may be used for these layers.

### SUMMARY OF INVENTION

The layer of the touch sensor and the layer of the heater may be deformed due to a pressure generated when the driver grips the rim. Further, when a metal material is contained in the layer of the touch sensor or the layer of the heater, plastic deformation occurs, and thus the layer may not return to an original shape. In such a case, the layer of the touch sensor and the layer of the heater may come into contact with each other due to the deformed members penetrating the insulator that insulates between the layer of the touch sensor and the layer of the heater.

As a result, a short circuit occurs between a circuit of the touch sensor and a circuit of the heater, and the touch sensor and the heater may not operate normally.

The present disclosure may be implemented by the following aspects.
(1) According to a first aspect of the present disclosure, a sensing device is provided. The sensing device includes:
   a load unit including a conductive portion having conductivity and a base material portion supporting the conductive portion and configured to be covered by the conductive portion;
   a covering portion laminated to cover the conductive portion;
   a sensor circuit configured to detect an object in contact with the covering portion; and
   a heater circuit configured to cause the conductive portion to generate heat, in which the sensor circuit is configured to detect the object according to a change in a state of the conductive portion,
   the sensor circuit includes a sensor wiring connection portion electrically connected to the conductive portion, the sensor wiring connection portion being supported by the base material portion in the load unit,
   the heater circuit includes a positive wiring connection portion and a negative wiring connection portion that are electrically connected to the conductive portion, the positive wiring connection portion and the negative wiring connection portion being supported by the base material portion in the load unit,
   the heater circuit is configured to heat the conductive portion between the positive wiring connection portion and the negative wiring connection portion, and
   in a cross-section showing a laminated structure of the conductive portion and the covering portion, the sensor wiring connection portion, the positive wiring connection portion, and the negative wiring connection portion are positioned apart from one another while being in contact with a layer representing the conductive portion.
   In such an aspect, the sensor wiring connection portion, the positive wiring connection portion, and the negative wiring connection portion are positioned apart from one another while being in contact with the layer representing the conductive portion. Therefore, a short circuit due to direct contact between the connection portions is less likely to occur. With such an aspect, in the sensing device, in a case where a pressure is applied to the conductive portion by the object in contact with the covering portion, even if any of the sensor wiring connection portion, the positive wiring connection portion, and the negative wiring connection portion is deformed, contact thereamong can be prevented. That is, in the sensing device, a short circuit between the sensor circuit and the heater circuit can be prevented.
(2) The above sensing device may further include:
   a switching circuit configured to switch an operation of the sensor circuit and an operation of the heater circuit; and
   a control circuit configured to control the sensing device, and
   the sensor circuit may further be configured to cut off a connection with the conductive portion, and
   the control circuit may be configured to
      switch the operation of the sensor circuit and the operation of the heater circuit by the switching circuit, and
      cut off the connection between the sensor circuit and the conductive portion by the sensor circuit during the operation of the heater circuit.
   With this aspect, the sensor circuit and the heater circuit do not operate at the same time. Further, the sensor circuit cuts off the connection with the conductive portion during the operation of the heater circuit. In general, a voltage applied to heat the conductive portion is higher than a voltage applied to the conductive portion for a purpose of detection. Therefore, when the sensor circuit is connected to the conductive portion during the operation of the heater circuit, a current may flow from the heater circuit into the sensor circuit. However, in the sensing device, by cutting off an inflow of the current from the heater circuit to the sensor circuit, a failure of the sensing device due to the inflow of the current to the sensor circuit can be prevented.
(3) In the above sensing device,
   when the base material portion is developed on a plane,
      the base material portion may have a rectangular shape,
      the sensor wiring connection portion may be positioned along a short side of the base material portion,
      the positive wiring connection portion may be positioned along one of long sides of the base material portion, and
      the negative wiring connection portion may be positioned along the other of the long sides of the base material portion.
   In such an aspect, the distance between the positive wiring connection portion and the negative wiring connection portion is shorter than that in the case in which the positive wiring connection portion and the negative wiring connection portion are positioned along the short sides. When the conductive portion is heated by the heater circuit, the heat generation amount changes according to the electrical resistance value of the conductive portion. The electrical resistance value of the conductive portion depends on the distance between the positive wiring connection portion and the negative wiring connection portion. That is, the electrical resistance value of the conductive portion is smaller than that in the case in which the positive wiring connection portion and the negative wiring connection portion are positioned along the short sides. As the electrical resistance value decreases, the applied voltage may be more likely to decrease in the sensing device. Therefore, in the sensing device, the heater circuit may be easily designed.
(4) In the above sensing device,
   when the base material portion is developed on a plane,
      the positive wiring connection portion and the negative wiring connection portion may be positioned away from both end portions of the short side along which the sensor wiring connection portion is positioned.
   With such an aspect, the sensor wiring connection portion positioned along the short side of the base material portion and the positive wiring connection portion and the negative wiring connection portion positioned along the long sides of the base material portion are less likely to be close to each other. Therefore, in the sensing device, contact between the sensor wiring connection portion and the positive wiring connection portion or the negative wiring connection portion can be prevented.
(5) In the sensing device,
   the control circuit may be configured to, according to an instruction of a user, switch between
      a switching mode in which the operation of the heater circuit and the operation of the sensor circuit are alternately switched, and
      a sensor operation mode in which only the sensor circuit out of the heater circuit and the sensor circuit is operated.
   With such an aspect, the control circuit can detect an object in contact with the covering portion without heating the conductive portion in the sensor operation mode. Further, the control circuit can warm the conductive portion while realizing the same detection function in the switching mode. Accordingly, the sensing device can provide high convenience as compared with an aspect in which one of the sensor circuit and the heater circuit can be operated.
(6) According to the second aspect of the present disclosure, there is provided a steering wheel including:
   a rim to be gripped by a driver, the rim including a core metal portion inside a cross-section thereof; and
   a sensing device, in which
   the sensing device includes
      a load unit including a conductive portion having conductivity and a base material portion supporting the conductive portion and configured to be covered by the conductive portion,
      a covering portion laminated to cover the conductive portion,
      a sensor circuit configured to detect an object in contact with the covering portion, and
      a heater circuit configured to cause the conductive portion to generate heat, the load unit and the covering portion are disposed on the rim to cover the core metal portion,
   the sensor circuit is configured to detect the object according to a change in a state of the conductive portion, and
   the sensor circuit includes a sensor wiring connection portion electrically connected to the conductive portion,
   the sensor wiring connection portion being supported by the base material portion in the load unit,
   the heater circuit includes a positive wiring connection portion and a negative wiring connection portion that are electrically connected to the conductive portion, the positive wiring connection portion and the negative wiring connection portion being supported by the base material portion in the load unit,
   the heater circuit is configured to heat the conductive portion between the positive wiring connection portion and the negative wiring connection portion, and in a cross-section showing a laminated structure of the conductive portion and the covering portion, the sensor wiring connection portion, the positive wiring connection portion, and the negative wiring connection portion are positioned apart from one another while being in contact with a layer representing the conductive portion.
   In such an aspect, the sensor wiring connection portion, the positive wiring connection portion, and the negative wiring connection portion are positioned apart from one another while being in contact with the layer representing the conductive portion. Therefore, a short circuit due to direct contact between the connection portions is less likely to occur. With such an aspect, in the steering wheel, in a case where a pressure is applied to the conductive portion by an object in contact with the covering portion, even if any of the sensor wiring connection portion, the positive wiring connection portion, and the negative wiring connection portion is deformed, contact thereamong can be prevented. That is, in the steering wheel, the short circuit between the sensor circuit and the heater circuit can be prevented.

### BRIEF DESCRIPTION OF DRAWINGS

Exemplary embodiment(s) of the present invention will be described in detail based on the following figures, wherein:

FIG. 1 is a diagram showing a schematic configuration of a sensing device of a first embodiment;

FIG. 2 is a cross-sectional view of a load unit;

FIG. 3 is a diagram showing a schematic configuration of a sensing device of a second embodiment;

FIG. 4 is a diagram showing a schematic configuration of a sensing device of a third embodiment;

FIG. 5 is a diagram of a steering wheel according to a fourth embodiment; and

FIG. 6 is a cross-sectional view of a rim of the steering wheel.

### DESCRIPTION OF EMBODIMENTS

### A. First Embodiment

### A-1. Sensing Device

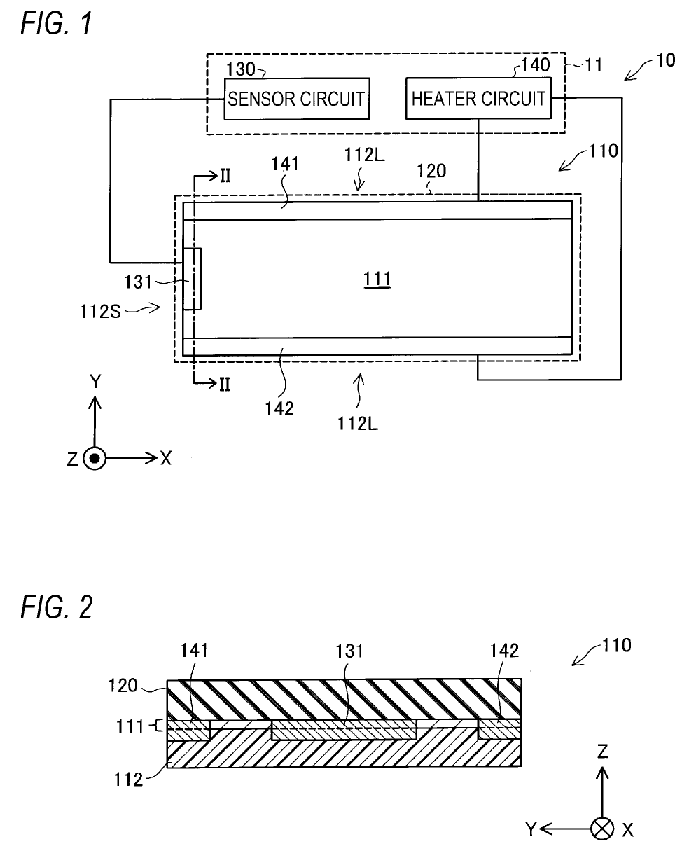

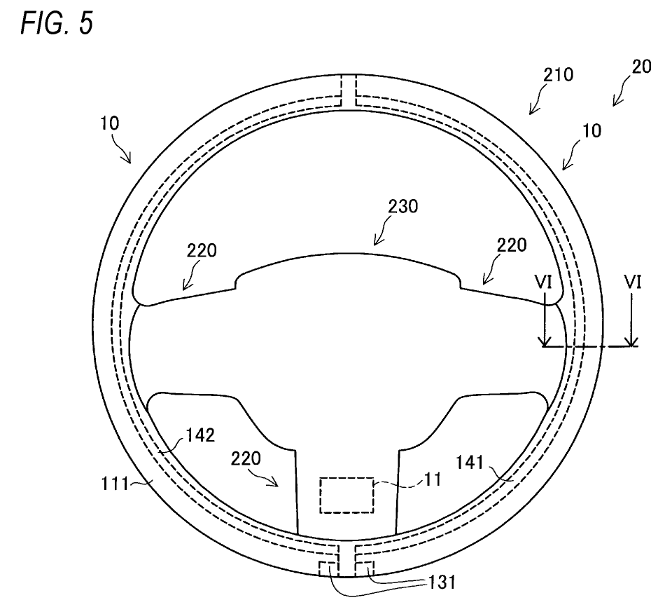

FIG. 1 is a diagram showing a schematic configuration of a sensing device 10 of a first embodiment. The sensing device 10 is applied to various objects. The sensing device 10 can detect contact of an object and warm an application target. For example, the sensing device 10 is disposed on a rim 210 of a steering wheel 20. In such a case, sensing device 10 can detect gripping of the rim 210 by a driver and warm hands of the driver via the rim 210. However, the sensing device 10 may be applied to a seat sheet, a console box, or the like of an automobile in addition to the steering wheel 20. The application of the sensing device 10 to the steering wheel 20 will be described in detail in another embodiment. Reference numerals related to the steering wheel 20 are shown in FIG. 5.

A load unit 110 provided in the sensing device 10 constitutes a range for detecting contact of an object and functions as a heat generation element. Depending on an application target, the load unit 110 is used in a three-dimensional shape instead of a plane shape. That is, the load unit 110 may be three-dimensionally formed according to a shape of the application target. For example, when the sensing device 10 is disposed on the rim 210 of the steering wheel 20, a base material portion 112 is used in a state of being curved in a tubular shape. However, in the first embodiment, in order to facilitate understanding of the technique, a case in which the load unit 110 is developed on a plane will be described as a reference. Even when the load unit 110 is three-dimensionally formed, a basic structure and function of the sensing device 10 are similar to those when the load unit 110 is developed on a plane. Hereinafter, "when the load unit 110 is developed on a plane" has the same meaning as "when the base material portion 112 is developed on a plane".

The sensing device 10 includes a load unit 110, a covering portion 120, a sensor circuit 130, and a heater circuit 140. In FIG. 1, in order to show an internal structure of the load unit 110, only a contour of the covering portion 120 covering the load unit 110 is shown.

In FIG. 1, an XYZ orthogonal coordinate system is defined to describe a structure of the load unit 110. In FIG. 1, an X-axis direction is a direction along a long side 112L of the base material portion 112 provided in the load unit 110. A Y-axis direction is a direction along a short side 112Sof the base material portion 112. A Z-axis direction is a thickness direction of the sensing device 10. That is, the Z-axis direction is a direction in which components positioned in the load unit 110 are laminated. The orthogonal coordinate system is defined to describe the structure of the load unit 110, and is not used to define a position of a circuit unit 11 including the sensor circuit 130 and the heater circuit 140.

The load unit 110 functions as the heat generation element. Further, the load unit 110 constitutes a range for detecting an object in contact with the covering portion 120. These functions will be described in detail later. The load unit 110 includes a conductive portion 111 and the base material portion 112.

FIG. 2 is a cross-sectional view of the load unit 110. The base material portion 112 supports the conductive portion 111. Further, the base material portion 112 is configured to be covered by the conductive portion 111. More specifically, the base material portion 112 has a rectangular shape when being developed on a plane. In FIG. 1, the base material portion 112 is covered by the conductive portion 111 and a wiring connection portion to be described later, and thus is not shown. However, in a shown case, the base material portion 112 has a similar rectangular shape. The "wiring connection portion" collectively refers to a sensor wiring connection portion 131, a positive wiring connection portion 141, and a negative wiring connection portion 142. Specifically, as shown in FIG. 2, the base material portion 112 is covered by the conductive portion 111 by laminating the conductive portion 111 on an entire surface of one of a front surface and a back surface.

The base material portion 112 is made of, for example, an insulating knit material. As fibers constituting the knit material, a flexible resin material is used. As the fibers constituting the knit material, for example, polyester fibers are used. The base material portion 112 is made of the knit material, and thus the base material portion 112 has flexibility and elasticity. Accordingly, in the sensing device 10, the load unit 110 can be assembled to an application target having a curved surface or a complicated shape, such as the rim 210 of the steering wheel 20.

However, as the fibers constituting the knit material, other fibers such as nylon fibers may be used. Further, the base material portion 112 may be a film material, a woven fabric, or a nonwoven fabric.

The conductive portion 111 is formed by applying a conductive coating material to one of the surfaces of the base material portion 112. When the base material portion 112 is made of the knit material, a part of the conductive coating material penetrates inside the base material portion 112. Therefore, the base material portion 112 supports the conductive portion 111 in a state where a part of the conductive portion 111 penetrates inside the base material portion 112. In the present specification, a state in which the base material portion 112 includes a part of the conductive portion 111 also means that the conductive portion 111 is laminated on the base material portion 112. In FIG. 2, in order to facilitate understanding of the technique, layers of the conductive portion 111 and the base material portion 112 are shown in a separated state.

The conductive portion 111 has conductivity. As described above, the conductive portion 111 is formed on the base material portion 112 by applying the conductive coating material. The conductive coating material is, for example, a coating material in which multi-walled carbon nanotubes and polyester are mixed. Since metal-based particles are not used in such a coating material, the conductive portion 111 easily returns to an original state even when being deformed by receiving pressure. Further, when the conductive portion 111 includes a metal portion, the metal portion may become sharp due to deformation. The sharp metal portion may penetrate through a component in contact therewith and thus come into contact with another component not in contact therewith. That is, the conductive portion 111 may be a short circuit with another component. However, when the conductive portion 111 does not include a metal portion, such a short circuit is prevented.

However, as the conductive coating material, a coating material containing metal-based particles such as nickel or silver may be used, or a conductive carbon-based coating material other than the multi-walled carbon nanotubes may be used.

A thickness of the conductive portion 111 varies depending on the number of times of application of the coating material or an amount of the coating material to be applied. The thickness of the conductive portion 111 affects an electrical resistance value of the conductive portion 111. Therefore, the electrical resistance value decreases as the thickness of the conductive portion 111 increases. Meanwhile, the electrical resistance value increases as the thickness of the conductive portion 111 decreases. That is, the thickness of the conductive portion 111 is adjusted according to the electrical resistance value required for the conductive portion 111. The required electrical resistance value is adjusted according to a required heat generation amount. Therefore, the thickness of the conductive portion 111 is adjusted according to a heat generation amount required in the application target of the sensing device 10.

Further, sensitivity of detection of the sensor circuit 130 is also adjusted by adjusting the electrical resistance value of the conductive portion 111. For example, when the conductive portion 111 is used as an electrode in a capacitive touch sensor, the electrical resistance value of the electrode affects a speed of charge and discharge. For example, as the electrical resistance value of the electrode increases, a rate of charge and discharge is delayed, and thus rise and fall of a voltage are delayed. Accordingly, it is difficult to detect a change in capacitance caused by contact of an object. Therefore, the sensitivity of the detection decreases. Therefore, the thickness of the conductive portion 111 is adjusted according to sensitivity of detection required in the application target of the sensing device 10.

The thickness of the conductive portion 111 is adjusted to, for example, about 100 μm when the sensing device 10 is applied to the steering wheel 20. In general, a thickness of an electrode or a heat generation element of a touch sensor disposed on the rim 210 of the steering wheel 20 is about 1 mm. Therefore, a thickness of the rim 210 can be easily adjusted by replacing a constituent element of the electrode or the heat generation element with the sensing device 10. More specifically, the rim 210 of the steering wheel 20 is designed within a specific thickness range to be easily gripped by the driver. By replacing the constituent element of the electrode or the heat generation element with the sensing device 10, it is easier to adjust the thickness of the rim 210 within that range than in a case of using the electrode or the heat generation element with a related-art thickness.

Further, since a component of the rim 210 is thinned by being replaced with the sensing device 10, the entire rim 210 is easily warmed. Further, since a proportion of the electrode or the heat generation element in a cross-section of the rim 210 is small, the number of types of molds necessary for molding the rim 210 may be reduced.

The covering portion 120 shown in FIG. 2 is laminated to cover the conductive portion 111. The covering portion 120 is made of a flexible insulating material. A specific material is selected according to the application target of the sensing device 10. When the sensing device 10 is applied to the steering wheel 20, the covering portion 120 is made of, for example, leather. However, the covering portion 120 may be made of a resin material.

A thickness of the covering portion 120 is adjusted based on the sensitivity required for the sensing device 10 to detect the contact of an object. For example, when the conductive portion 111 is used as an electrode in a capacitive touch sensor, a distance between the object in contact and the conductive portion 111 is determined by the thickness of the covering portion 120. Since an amount of change in capacitance increases as the distance decreases, the sensitivity of detection increases as the thickness of the covering portion 120 decreases. Therefore, the thickness of the covering portion 120 is adjusted according to the required sensitivity of detection.

The sensor circuit 130 shown in FIG. 1 detects an object in contact with the covering portion 120. Specifically, the sensor circuit 130 is a circuit for operating a capacitive touch sensor. The sensor circuit 130 includes a detection circuit which is not shown, and the sensor wiring connection portion 131 which is electrically connected to the conductive portion 111. Further, the sensor circuit 130 uses the conductive portion 111 as an electrode for detecting contact of an object. The detection circuit includes a power supply and a microcomputer.

That is, the sensor circuit 130 controls, by the detection circuit, charge and discharge of electric charges in the conductive portion 111 via the sensor wiring connection portion 131. When an object comes into contact with the covering portion 120, capacitance of the conductive portion 111 changes because the object approaches the conductive portion 111. The sensor circuit 130 detects the contact of the object by detecting a change in voltage accompanying the change in capacitance. That is, the sensor circuit 130 detects an object according to a change in a state of the conductive portion 111.

The sensor wiring connection portion 131 shown in FIG. 2 is disposed to be supported by the base material portion 112 in the load unit 110. More specifically, the sensor wiring connection portion 131 is joined to a portion of the base material portion 112 at which the conductive portion 111 is positioned. Accordingly, the sensor wiring connection portion 131 is electrically connected to the conductive portion 111. For example, when the base material portion 112 is made of the knit material, the sensor wiring connection portion 131 is joined to be knitted into a portion of the base material portion 112 at which the conductive portion 111 is positioned.

Therefore, the sensor wiring connection portion 131 is made of conductive fibers. For example, the sensor wiring connection portion 131 is made of a conductive composite material in which copper fibers are wound around a polyester thread. However, the sensor wiring connection portion 131 may be made of metal-plated fibers or single metal fibers.

A position of the sensor wiring connection portion 131 in the base material portion 112 will be described in detail later.

The heater circuit 140 shown in FIG. 1 causes the conductive portion 111 to generate heat. The heater circuit 140 includes a power supply and a temperature control unit including a microcomputer. The temperature control unit and the power supply are not shown. The heater circuit 140 further includes the positive wiring connection portion 141 and the negative wiring connection portion 142 that are electrically connected to the conductive portion 111. In addition, the heater circuit 140 uses the conductive portion 111 as the heat generation element. That is, the positive wiring connection portion 141 and the negative wiring connection portion 142 function as electrodes in the heat generation element. The heater circuit 140 heats the conductive portion 111 according to the electrical resistance value of the conductive portion 111 by energizing from the positive wiring connection portion 141 toward the negative wiring connection portion 142 by the power supply. That is, the conductive portion 111 is heated between the positive wiring connection portion 141 and the negative wiring connection portion 142. Further, the heater circuit 140 adjusts a temperature of the conductive portion 111 by adjusting a current to be supplied to the conductive portion 111 using the temperature control unit.

The positive wiring connection portion 141 and the negative wiring connection portion 142 shown in FIG. 2 are disposed to be supported by the base material portion 112 in the load unit 110. The positive wiring connection portion 141 and the negative wiring connection portion 142 are joined to a portion of the base material portion 112 at which the conductive portion 111 is positioned by a method similar to a joining method of the sensor wiring connection portion 131 and the base material portion 112. Accordingly, the positive wiring connection portion 141 and the negative wiring connection portion 142 are electrically connected to the conductive portion 111.

As shown in FIG. 2, in a cross-section showing a laminated structure of the conductive portion 111 and the covering portion 120, the sensor wiring connection portion 131, the positive wiring connection portion 141, and the negative wiring connection portion 142 are positioned apart from one another while being in contact with a layer representing the conductive portion 111. That is, each of the wiring connection portions is supported by the base material portion 112 in a state of including a part of the layer formed by the conductive portion 111. Further, the wiring connection portions are arranged so as not to overlap one another in cross-section.

However, each of the wiring connection portions may not include a part of the layer formed by the conductive portion 111. Each of the wiring connection portions may be in contact with the layer representing the conductive portion 111. That is, each of the wiring connection portions may be disposed to ride on a boundary surface of the layer representing the conductive portion 111.

The wiring connection portions are electrically connected via the conductive portion 111. However, a current is less likely to flow between the wiring connection portions through the conductive portion 111 as compared with a case in which the wiring connection portions are directly connected. In the present specification, a state in which the wiring connection portions are directly connected means a short circuit state. Therefore, a state in which the wiring connection portions are electrically connected via the conductive portion 111 is not included in the short circuit state.

### A-2: Position of Each of Wiring Connection Portions

When the base material portion 112 is developed on a plane, the base material portion 112 has a rectangular shape. Therefore, as shown in FIG. 1, the base material portion 112 has a pair of long sides 112L and a pair of short sides 112S.

The sensor wiring connection portion 131 is positioned along the short side 112S of the base material portion 112. That is, the sensor wiring connection portion 131 is disposed parallel to the short sides 112S in a strip shape.

The positive wiring connection portion 141 is positioned along one of the long sides 112L of the base material portion 112. The negative wiring connection portion 142 is positioned along the other of the long sides 112L of the base material portion 112. Each of the positive wiring connection portion 141 and the negative wiring connection portion 142 is arranged in parallel to the long sides 112L in a strip shape.

As described above, with such a configuration, the sensing device 10 can be applied to various targets. Further, the sensing device 10 can detect contact of an object in the application target and warm the application target.

In such an aspect, the sensor wiring connection portion 131, the positive wiring connection portion 141, and the negative wiring connection portion 142 are positioned apart from one another while being in contact with the layer representing the conductive portion 111. Therefore, a short circuit due to direct contact between the connection portions is less likely to occur. With such an aspect, in the sensing device 10 of the present embodiment, in a case where a pressure is applied to the conductive portion 111 by an object in contact with the covering portion 120, even if any of the sensor wiring connection portion 131, the positive wiring connection portion 141, and the negative wiring connection portion 142 is deformed, contact thereamong can be prevented. That is, in the sensing device 10 of the present embodiment, a short circuit between the sensor circuit 130 and the heater circuit 140 can be prevented.

Further, the positive wiring connection portion 141 and the negative wiring connection portion 142 are positioned along the long sides 112L. In such an aspect, a distance between the positive wiring connection portion 141 and the negative wiring connection portion 142 is shorter than that in a case in which the positive wiring connection portion 141 and the negative wiring connection portion 142 are positioned along the short sides 112S. When the conductive portion 111 is heated by the heater circuit 140, a heat generation amount changes according to the electrical resistance value of the conductive portion 111. The electrical resistance value of the conductive portion 111 depends on the distance between the positive wiring connection portion 141 and the negative wiring connection portion 142. That is, the electrical resistance value of the conductive portion 111 is smaller than that in the case in which the positive wiring connection portion 141 and the negative wiring connection portion 142 are positioned along the short sides 112S. As the electrical resistance value decreases, the applied voltage may be more likely to decrease in the sensing device 10 of the present embodiment. Therefore, in the sensing device 10 of the present embodiment, the heater circuit 140 may be easily designed.

### B. Second Embodiment

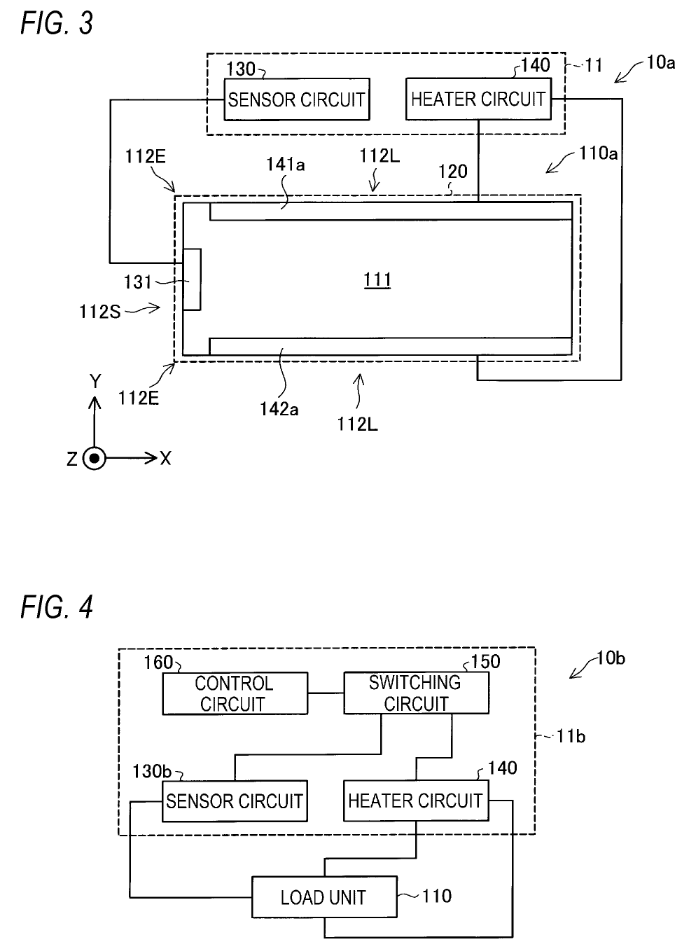

FIG. 3 is a diagram showing a schematic configuration of a sensing device 10a of a second embodiment. In the above embodiment, a positive wiring connection portion 141a and a negative wiring connection portion 142a may be further positioned away from both end portions 112E of the short side 112S along which the sensor wiring connection portion 131 is positioned. More specifically, in FIG. 3, the positive wiring connection portion 141a and the negative wiring connection portion 142a may be disposed such that ranges of the positive wiring connection portion 141a and the negative wiring connection portion 142a do not overlap a range of the sensor wiring connection portion 131 when a load unit 110a is viewed along the Y-axis direction. In the second embodiment, the same components as those in the first embodiment are denoted by the same reference numerals. Further, in the second embodiment, components having functions different from those of the first embodiment are denoted by reference numerals with "a" attached.

With such an aspect, the sensor wiring connection portion 131 positioned along the short side 112S of the base material portion 112 and the positive wiring connection portion 141a and the negative wiring connection portion 142a positioned along the long sides 112L of the base material portion 112 are less likely to be close to each other. Therefore, in the sensing device 10aof the present embodiment, contact between the sensor wiring connection portion 131 and the positive wiring connection portion 141a or the negative wiring connection portion 142a can be prevented.

### C. Third Embodiment

FIG. 4 is a diagram showing a schematic configuration of a sensing device 10b of a third embodiment. The sensing device 10b may include a control circuit 160 and a switching circuit 150 in addition to the configuration of the sensing device 10 of the first embodiment. Therefore, a circuit unit 11b of the third embodiment includes the control circuit 160 and the switching circuit 150. In the third embodiment, the same components as those in the first embodiment are denoted by the same reference numerals. In the third embodiment, components having functions different from those of the first embodiment are denoted by reference numerals with "b" attached. Further, in FIG. 4, illustration of a part of the load unit 110 is omitted.

The switching circuit 150 switch an operation of a sensor circuit 130b and an operation of the heater circuit 140. The switching circuit 150 includes, for example, a relay and a drive circuit thereof. The relay switches on and off of a power supply of the sensor circuit 130b and the heater circuit 140. That is, the switching circuit 150 operates the relay by the drive circuit based on a command of the control circuit 160 to supply power to either the sensor circuit 130b or the heater circuit 140.

In the third embodiment, the sensor circuit 130b can further cut off the connection with the conductive portion 111. For example, the sensor circuit 130b includes a relay in a wiring connected to the conductive portion 111. The sensor circuit 130b cuts off the electrical connection between the sensor circuit 130b and the conductive portion 111 by turning off the relay.

In the above circuit, an element implemented by the relay may be implemented by a semiconductor switch such as a transistor.

The control circuit 160 controls the sensing device 10b. Specifically, the control circuit 160 is a microcomputer. The control circuit 160 may be used as a microcomputer of the sensor circuit 130b or the heater circuit 140. The control circuit 160 switches the operation of the sensor circuit 130b and the operation of the heater circuit 140 by the switching circuit 150. That is, the control circuit 160 operates, by the switching circuit 150, either a function of detecting contact of an object by the sensor circuit 130b or a function of heating the conductive portion 111 by the heater circuit 140. The control circuit 160 cuts off the connection between the sensor circuit 130b and the conductive portion 111 by the sensor circuit 130b during the operation of the heater circuit 140.

With such an aspect, the sensor circuit 130b and the heater circuit 140 do not operate at the same time. Further, the sensor circuit 130b cuts off the connection with the conductive portion 111 during the operation of the heater circuit 140. In general, a voltage applied to heat the conductive portion 111 is higher than a voltage applied to the conductive portion 111 for a purpose of detection. Therefore, when the sensor circuit 130b is connected to the conductive portion 111 during the operation of the heater circuit 140, a current may flow from the heater circuit 140 into the sensor circuit 130b. However, in the sensing device 10b of the present embodiment, by cutting off an inflow of the current from the heater circuit 140 to the sensor circuit 130b, a failure of the sensing device 10 due to the inflow of the current to the sensor circuit 130b can be prevented.

### D. Fourth Embodiment

As described above, when being disposed on the rim 210 of the steering wheel 20, the sensing device 10 can detect gripping of the rim 210 by the driver and can warm the hands of the driver via the rim 210. Hereinafter, the steering wheel 20 to which the sensing device 10 is applied will be described.

FIG. 5 is a diagram of the steering wheel 20 according to a fourth embodiment. FIG. 5 shows a plan view of the steering wheel 20 when the steering wheel 20 is viewed from the driver. The steering wheel 20 includes the rim 210 formed in an annular shape, spokes 220 extending from the rim 210 toward a central portion of the rim 210, a pad 230 positioned at the central portion, and the sensing device 10.

In the plan view of FIG. 5, the sensing device 10 applied to the steering wheel 20 is disposed on a portion on the right half rim 210 of the steering wheel 20 and a portion on the left half rim 210. In each of the sensing devices 10, each of the long sides 112L of the base material portion 112 is disposed in a direction in which the annular rim 210 extends. Therefore, the sensor wiring connection portion 131 is positioned, for example, at a lowermost portion of the steering wheel 20 in the plan view of FIG. 5. However, the sensor wiring connection portion 131 may be positioned on an upper side of the steering wheel 20 in the plan view of FIG. 5. The circuit unit 11 including the sensor circuit 130, the heater circuit 140, and the like is housed inside the spokes 220, for example. In order to facilitate understanding of the technique, illustration of the wirings is omitted in FIG. 5.

On the steering wheel 20, one sensing device 10 may be disposed, or three or more sensing devices 10 may be disposed. Further, the sensing device 10 may be disposed on a part of the rim 210.

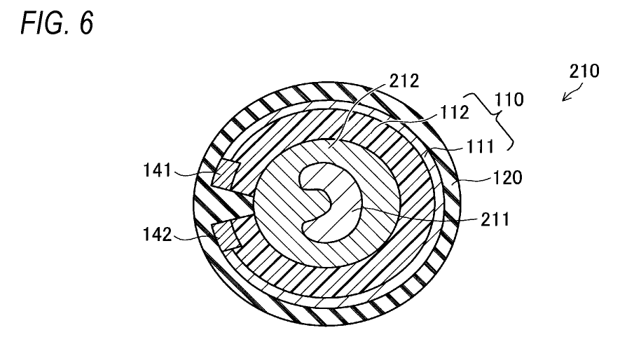

FIG. 6 is a cross-sectional view of the rim 210 of the steering wheel 20. FIG. 6 shows a cross-sectional view perpendicular to the direction in which the annular rim 210 extends. The rim 210 is a portion of the steering wheel 20 that is gripped by the driver. The rim 210 has a circular cross-section. The rim 210 includes, inside the cross-section, a core metal portion 211 for maintaining a shape of the rim 210, and a core metal covering portion 212 covering the core metal portion 211. However, the rim 210 may not include the core metal covering portion 212.

The sensing device 10 is disposed inside the rim 210 in a state of being curved along a contour of the cross-section of the rim 210. Accordingly, as shown in FIG. 5, the positive wiring connection portion 141 and the negative wiring connection portion 142 are positioned on a side where the pad 230 is positioned in the rim 210.

As shown in FIG. 6, the load unit 110 and the covering portion 120 in the sensing device 10 are disposed on the rim 210 to cover the core metal portion 211. More specifically, the load unit 110 covers the core metal portion 211 in a state where the base material portion 112 is in contact with the core metal covering portion 212. Further, the covering portion 120 is laminated on the load unit 110. Thus, the sensing device 10 constitutes an outermost layer of the rim 210.

As described above, when the driver grips the rim 210, the hands are in direct contact with the covering portion 120 constituting a surface of the rim 210. The sensing device 10 detects the contact by the sensor circuit 130. Further, the sensing device 10 can warm the entire rim 210 by the heater circuit 140 causing the conductive portion 111 to generate heat.

In such an aspect, the sensor wiring connection portion 131, the positive wiring connection portion 141, and the negative wiring connection portion 142 are positioned apart from one another while being in contact with the layer representing the conductive portion 111. Therefore, a short circuit due to direct contact between the connection portions is less likely to occur. With such an aspect, in the steering wheel 20 of the present embodiment, in a case where a pressure is applied to the conductive portion 111 by an object in contact with the covering portion 120, even if any of the sensor wiring connection portion 131, the positive wiring connection portion 141, and the negative wiring connection portion 142 is deformed, contact thereamong can be prevented. That is, in the steering wheel 20 of the present embodiment, a short circuit between the sensor circuit 130 and the heater circuit 140 can be prevented.

### E. Fifth Embodiment

In the above embodiments, the control circuit 160 may further have a switching mode and a sensor operation mode.

In the sensor operation mode, only the sensor circuit 130 among the heater circuit 140 and the sensor circuit 130 is operated. Depending on a temperature of an environment in which the sensing device 10 is used, it may not be necessary to warm the conductive portion 111. In such a case, the sensing device 10 does not heat the conductive portion 111.

In the switching mode, an operation of the heater circuit 140 and an operation of the sensor circuit 130 are alternately switched. More specifically, in the switching mode, the operation of the heater circuit 140 and the operation of the sensor circuit 130 are alternately switched at intervals shorter than one second, for example. Accordingly, the sensing device 10 can warm the conductive portion 111 while realizing substantially the same detection function.

In addition, the control circuit 160 may switch between the two modes according to an instruction from a user. The instruction of the user is performed by, for example, a touch operation on the covering portion 120 performed by the user. However, the instruction of the user may be input to the control circuit 160 in response to an operation from the user when the sensing device 10 includes an operation unit.

With such an aspect, the control circuit 160 can detect an object in contact with the covering portion 120 without heating the conductive portion 111 in the sensor operation mode. Further, the control circuit 160 can warm the conductive portion 111 while realizing the same detection function in the switching mode. Accordingly, the sensing device 10 of the present embodiment can provide high convenience as compared with an aspect in which one of the sensor circuit 130 and the heater circuit 140 can be operated.

### F. Another Embodiment

(F1) In the above embodiments, the sensor circuit 130 detects contact by detecting a change in capacitance caused by contact of an object. However, the sensor circuit 130 may detect the contact by detecting a change in the electrical resistance value caused by the contact of the object. That is, the sensor circuit 130 may be a circuit for operating a resistive touch sensor.

Further, the sensor circuit 130 may be a circuit for detecting water droplets adhering to the covering portion 120. More specifically, the sensor circuit 130 detects water droplets based on a change in the capacitance of the conductive portion 111 caused by the water droplets adhering to the covering portion 120.

(F2) In the above embodiments, the base material portion 112 and the covering portion 120 are different components. However, the base material portion 112 and the covering portion 120 may be implemented by the same component. In such a case, the load unit 110 is configured such that the conductive portion 111 is disposed on one of the surfaces of the covering portion 120 and an object comes into contact with the other surface of the covering portion 120. That is, the conductive portion 111 is formed by directly applying the conductive coating material to a surface of the covering portion 120 opposite to a surface exposed outside. Further, the sensor wiring connection portion 131, the positive wiring connection portion 141, and the negative wiring connection portion 142 are disposed on the covering portion 120 apart from one another while being in contact with the layer representing the conductive portion 111. With such an aspect, in the sensing device 10, the number of components constituting the base material portion 112 can be reduced. Further, in the sensing device 10, the load unit 110 can be made thinner than in a case where the base material portion 112 and the covering portion 120 are different components.

(F3) In the above embodiments, the steering wheel 20 has a structure including the core metal portion 211 inside the rim 210. However, the steering wheel 20 may include the rim 210 having a shell structure. The rim 210 having a shell structure has a hollow cross-section. In the rim 210 having a shell structure, a member corresponding to the core metal portion 211 in the rim 210 of the above embodiment constitutes an outermost layer having a hollow cross-section. That is, the shape of rim 210 is maintained by an outermost layer portion. Therefore, the rim 210 having a shell structure does not include the core metal portion 211 therein. In such a case, the base material portion 112 and the covering portion 120 may be constituted by the outermost layer portion. That is, the conductive portion 111 is formed on an inner surface of the outermost layer portion by applying the conductive coating material to the inner surface of the outermost layer portion.

(F4) In the above embodiments, the base material portion 112 has a rectangular shape. However, the base material portion 112 may have another shape according to a shape of the application target of the sensing device 10. For example, the base material portion 112 may have a quadrangular shape or a circular shape. Further, in the base material portion 112, a portion where each of the wiring connection portions is positioned may protrude from an outer shape. For example, in the rectangular base material portion 112, a part positioned on the short side 112S may protrude from a rectangular outer shape. Further, the sensor wiring connection portion 131 may be positioned at this portion. With such an aspect, the wiring connection portions are easily disposed apart from one another.

(F5) In the above embodiments, the sensor wiring connection portion 131 is positioned along the short side 112S of the base material portion 112. The positive wiring connection portion 141 is positioned along one of the long sides 112L of the base material portion 112. The negative wiring connection portion 142 is positioned along the other of the long sides 112L of the base material portion 112. However, the sensor wiring connection portion 131 may be positioned along the long side 112Lof the base material portion 112. In this case, the positive wiring connection portion 141 is positioned along one of the short sides 112S of the base material portion 112. The negative wiring connection portion 142 is positioned along the other of the short sides 112S of the base material portion 112.

(F6) In the above embodiments, the sensing device 10 may include an insulator at a position where the positive wiring connection portion 141 and the sensor wiring connection portion 131 are closest to each other. Similarly, the sensing device 10 may include an insulator at a position where the negative wiring connection portion 142 and the sensor wiring connection portion 131 are closest to each other. The insulator is formed by, for example, applying the insulating coating material. With such an aspect, the sensing device 10 can effectively prevent a short circuit at a closest position.

(F7) In the above embodiments, the rim 210 of the steering wheel 20 has an annular shape. However, the rim 210 is not limited to the annular shape, and may have any shape such as a polygonal contour or an elliptical contour. The rim 210 is not limited to an annular shape, and may include a plurality of gripping portions that are not continuous with each other, such as a right gripping portion and a left gripping portion.

(F8) In the above embodiments, the positive wiring connection portion 141 and the negative wiring connection portion 142 are positioned on the side where the pad 230 is positioned in the rim 210, as shown in FIG. 5. That is, the positive wiring connection portion 141 and the negative wiring connection portion 142 are positioned on an inner side of the steering wheel 20. However, the positive wiring connection portion 141 and the negative wiring connection portion 142 may be positioned on an outer side of the steering wheel 20.

The present disclosure is not limited to the embodiments described above, and can be implemented by various configurations without departing from the gist of the present disclosure. For example, the technical features in the embodiments corresponding to the technical features in the aspects described in the summary of the present disclosure can be replaced or combined as appropriate to solve a part or all of the problems described above or to achieve a part or all of the effects described above. The technical features may be appropriately deleted unless being described as necessary in the present specification.

What is claimed is:

1. A sensing device comprising:
a load unit including a conductive portion having conductivity and a base material portion supporting the conductive portion and configured to be covered by the conductive portion;
a covering portion laminated to cover the conductive portion;
a sensor circuit configured to detect an object in contact with the covering portion; and
a heater circuit configured to cause the conductive portion to generate heat, wherein
the sensor circuit is configured to detect the object according to a change in a state of the conductive portion,
the sensor circuit includes a sensor wiring connection portion electrically connected to the conductive portion, the sensor wiring connection portion being supported by the base material portion in the load unit,
the heater circuit includes a positive wiring connection portion and a negative wiring connection portion that are electrically connected to the conductive portion, the positive wiring connection portion and the negative wiring connection portion being supported by the base material portion in the load unit,
the heater circuit is configured to heat the conductive portion between the positive wiring connection portion and the negative wiring connection portion, and
in a cross-section showing a laminated structure of the conductive portion and the covering portion, the sensor wiring connection portion, the positive wiring connection portion, and the negative wiring connection portion are positioned apart from one another while being in contact with a layer representing the conductive portion.

2. The sensing device according to claim 1, further comprising:
a switching circuit configured to switch an operation of the sensor circuit and an operation of the heater circuit; and
a control circuit configured to control the sensing device, wherein
the sensor circuit is further configured to cut off a connection with the conductive portion, and
the control circuit is configured to
switch the operation of the sensor circuit and the operation of the heater circuit by the switching circuit, and
cut off the connection between the sensor circuit and the conductive portion by the sensor circuit during the operation of the heater circuit.

3. The sensing device according to claim 1, wherein
when the base material portion is developed on a plane,
the base material portion has a rectangular shape,
the sensor wiring connection portion is positioned along a short side of the base material portion,
the positive wiring connection portion is positioned along one of long sides of the base material portion, and
the negative wiring connection portion is positioned along the other of the long sides of the base material portion.

4. The sensing device according to claim 3, wherein
when the base material portion is developed on a plane,
the positive wiring connection portion and the negative wiring connection portion are positioned away from both end portions of the short side along which the sensor wiring connection portion is positioned.

5. The sensing device according to claim 2, wherein
the control circuit is configured to, according to an instruction of a user, switch between
a switching mode in which the operation of the heater circuit and the operation of the sensor circuit are alternately switched, and
a sensor operation mode in which only the sensor circuit out of the heater circuit and the sensor circuit is operated.

6. A steering wheel comprising:
a rim to be gripped by a driver, the rim including a core metal portion inside a cross-section thereof; and
a sensing device, wherein
the sensing device includes
a load unit including a conductive portion having conductivity and a base material portion supporting the conductive portion and configured to be covered by the conductive portion,
a covering portion laminated to cover the conductive portion,
a sensor circuit configured to detect an object in contact with the covering portion, and
a heater circuit configured to cause the conductive portion to generate heat, the load unit and the covering portion are disposed on the rim to cover the core metal portion,
the sensor circuit is configured to detect the object according to a change in a state of the conductive portion, and
the sensor circuit includes a sensor wiring connection portion electrically connected to the conductive portion, the sensor wiring connection portion being supported by the base material portion in the load unit,
the heater circuit includes a positive wiring connection portion and a negative wiring connection portion that are electrically connected to the conductive portion, the positive wiring connection portion and the negative wiring connection portion being supported by the base material portion in the load unit,
the heater circuit is configured to heat the conductive portion between the positive wiring connection portion and the negative wiring connection portion, and
in a cross-section showing a laminated structure of the conductive portion and the covering portion, the sensor wiring connection portion, the positive wiring connection portion, and the negative wiring connection portion are positioned apart from one another while being in contact with a layer representing the conductive portion.
